(19) United States
(12) Patent Application Publication
(10) Pub. No.: US 2016/0055764 A1
(43) Pub. Date: Feb. 25, 2016

(54) METHOD, DEVICE AND COMPUTER PROGRAM PRODUCT FOR MANAGING DRIVER SAFETY, METHOD FOR MANAGING USER SAFETY AND METHOD FOR DEFINING A ROUTE

(71) Applicant: JYVÄSKYÄN YLIOPISTO, Jyväskylän yliopisto (FI)

(72) Inventors: Tuomo Kujala, Jyväskylän yliopisto (FI); Timo Tokkonen, Jyväskylän yliopisto (FI)

(21) Appl. No.: 14/888,489

(22) PCT Filed: Feb. 4, 2014
(86) PCT No.: PCT/FI2014/050083

§ 371 Date: Nov. 2, 2015

(30) Foreign Application Priority Data
May 3, 2013 (FI) 20135456

(51) Int. Cl. G09B 19/16; G09B 5/00

(52) U.S. Cl. CPC G09B 19/167; G09B 5/00

(57) ABSTRACT

An enhancement for managing driver safety is presented. Using for example driver related information and/or information relating to circumstances surrounding a vehicle is stored in a driver mentoring application. The driver mentoring application executes visual demand algorithm using information relating at least to the driver and/or the surrounding circumstances. An application for tracking visual attention of the driver is launched and visual attention information is provided to the driver mentoring application. If the application detects that the visual attention is directed to something else than navigating the vehicle a timer is started to measure the time. Using a value received from the visual demand algorithm the driver mentoring application defines a threshold time for an intervention. If the measured time meets the defined threshold time mentoring is given to the driver to allocate more visual attention to navigating the vehicle.

### FIELD OF THE INVENTION

This invention relates to driver safety. More particularly, this invention relates to a method, an apparatus and a computer program product as defined in the preambles of the independent claims.

### BACKGROUND OF THE INVENTION

Even though the number of fatal road casualties has significantly decreased around the world from the early nineties, there are still more than 30 000 deaths annually alone in Europe due to traffic accidents. According to large field studies driver inattention is a major cause of traffic accidents. A special form of inattention, driver distraction, refers to diversion of driver's attention away from activities critical to safe driving towards competing activities. Distraction may be for example aural (the driver is not able to hear the sounds from traffic), cognitive (the driver is focused in thoughts about something else than driving), or manual (the driver is using his/her hands for something else than driving). Yet, because of the high visual demands of driving, the biggest risk factor is visual distraction—the driver does not have eyes on the road when the driving situation requires visual attention. Number one cause for visual distraction while driving is the use of mobile devices such as phones, PDAs, tablet computers etc. Other causes for visual distraction include passengers and performing tasks like eating, fixing make-up, shaving, eating etc. Field studies have shown that drivers are trying to keep diverging glance durations within safe limits but that often their allocation of visual attention is inefficient and unsafe—drivers take a look at a wrong place at a wrong time and/or look at a wrong place for too long given the visual demands of the traffic situation.

Some solutions have been introduced for monitoring and warning the driver. Some modern cars have lane-monitoring systems that give alerts to the driver when the car is about to leave the lane. Accessory and inbuilt driver fatigue monitors exist for detecting drowsy drivers for example by measuring the distance between eyelids and giving an alert to the driver. KR20050040307A presents a solution where a camera is used to analyze the direction where the eyes are directed to. Using this information together with information about the current speed a warning alert may be given to the driver. EP2483105 A1 on the other hand presents a driver safety application running on a mobile device. The application gathers real-time information about the current driving situation—evaluates risks and alerts the driver if needed.

All these existing solutions hopefully do increase road safety but they are all reactive, acting after the risk level has already risen. In addition, all of these fail to take individual differences into account—not all drivers are similar. Some drivers are more skilled than others and are able to perform multi-tasking while driving more efficiently than less skilled. For example an experienced driver can gather and process the visual information required for safe navigation of the vehicle much faster than a novice driver and also anticipates the upcoming demands of driving much more efficiently. Nor is the driving situation always the same. The use of a driver mentoring system has to be a positive experience for the driver—not an annoying and itself a distracting one.

Use of certain devices like mobile phone, navigator, fleet management devices, car multimedia systems etc. while driving does visually distract the driver but in some situations the use of them increase safety e.g. using a GPS navigator on unfamiliar roads. For a professional driver the use of mobile phone or other tools is often essential. On a long drive use of the multimedia system can help driver to keep alert. Furthermore, all glances away from the road ahead cannot be defined as visual distraction. The driver must occasionally check the meters and mirrors of the vehicle. In addition, to keep the driving pleasant, the driver must occasionally glance and adjust accessories, such as climate control, radio, and other in-vehicle information systems. When a diverging glance becomes a visual distraction, depends on the current visual demands of the driving situation, which are further dependent on the skill level of the driver.

### BRIEF DESCRIPTION OF THE INVENTION

The object of the present invention is to solve or alleviate at least part of the above mentioned problems. The objects of the present invention are achieved with a method, an apparatus and a computer program product according to the characterizing portions of the independent claims.

The preferred embodiments of the invention are disclosed in the dependent claims.

The present invention is based on a new method of monitoring and improving driving safety by using driver- and situation-specific factors while estimating the need to guide the user in allocating ones visual attention back to the driving environment before visual distraction and the associated risks are realized.

### BRIEF DESCRIPTION OF THE FIGURES

In the following the invention will be described in greater detail, in connection with preferred embodiments, with reference to the attached drawings, in which

FIG. 1 illustrates exemplary pictures of a driver allocating visual attention to different directions.

FIG. 2 illustrates a simplified picture of a driver in a vehicle with potential sources of visual distractions.

FIG. 3 illustrates a simplified picture of a driver in a vehicle allocating visual attention to navigating the vehicle and to a source of distraction.

The flow chart of FIG. 4 illustrates some characteristics of the Driver Mentoring Application.

FIG. 5 illustrates a simplified picture of a mobile device running the Driver Mentoring Application.

### DETAILED DESCRIPTION OF SOME EMBODIMENTS

The following embodiments are exemplary. Although the specification may refer to “an”, “one”, or “some” embodiment(s), this does not necessarily mean that each such reference is to the same embodiment(s), or that the feature only applies to a single embodiment. Single features of different embodiments may be combined to provide further embodiments.

In the following, features of the invention will be described with a simple example of a system architecture in which various embodiments of the invention may be implemented. Only elements relevant for illustrating the embodiments are described in detail. Various implementations of computer implemented processes, apparatuses and computer program products comprise elements that are generally known to a person skilled in the art and may not be specifically described herein.

While various aspects of the invention have been illustrated and described as block diagrams, message flow diagrams, or using some other pictorial representation, it is well understood that the illustrated units, blocks, device, system elements, procedures and methods may be implemented in, for example, hardware, software, firmware, special purpose circuits or logic, a computing device or some combination thereof.

These exemplary embodiments include methods and systems for monitoring a driver of a vehicle allocating his/her visual attention between navigating the vehicle and visually distractive objects taking into account individual characteristics of the driver, current driving situation, among many other variables for mentoring the driver when needed. The method is based on calculating a value describing current traffic situation with a Visual Demand Algorithm (VDA) using real-time context information and Driver Profile (DP). The VDA may be a part of a Driver Mentoring Application (DMA) which is capable of collecting information about the driver, the vehicle, traffic, weather, road conditions and so on. Using the collected real-time data and the value from the VDA, DMA computes a Threshold Time (TT) for intervention if the driver is not allocating the visual attention to navigating the vehicle. The visual attention is monitored with a camera or other suitable device and if the TT is met the DMA mentors the driver to allocate more visual attention to navigating the vehicle.

The systems may be implemented in many ways. VDA, DMA, means for mentoring the driver, means for collecting information may be all embodied on a same device or on two or more separate devices.

The invention also makes possible to gather and store information of the drivers on a remote database. The information about the drivers allocating their visual attention in various situations may be used for many purposes including developing the DMA and the VDA, planning roads and traffic management, improving vehicles and user interfaces of various devices, information for insurance companies or the police and so on. The information gathered from an individual can used e.g. for profiling. Such information stored and/or retrieved inside or outside of the device, can be used to both to predict and fine-tune driver specific inattention parameters. It can be accomplished for example by calculating how many times mentoring intervention has been triggered both long term and short term.

Such information may also give input to the driver directly or e.g. road planners about potential danger areas and how to avoid those. If the system is used for insurance benefits, insure companies may offer additional discount based on past behaviour calculated using embodiments of the current invention.

Embodiments of the invention can comprise one or more computer programs that embody the functions described herein and illustrated in the appended flow charts. However, it should be apparent that there could be many different ways of implementing the invention in computer programming, and the invention should not be construed as limited to any one set of computer program instructions. Further, a skilled programmer would be able to write such a computer program to implement an embodiment of the disclosed invention based on the flow charts and associated description in the application text. Therefore, disclosure of a particular set of program code instructions is not considered necessary for an adequate understanding of how to make and use the invention. The inventive functionality of the claimed invention will be explained in more detail in the following description, read in conjunction with the figures illustrating the program flow.

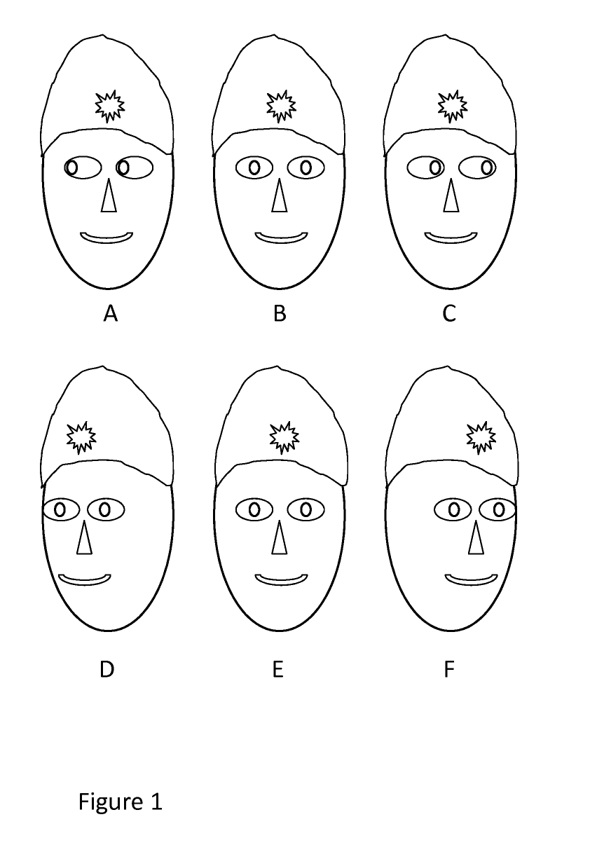

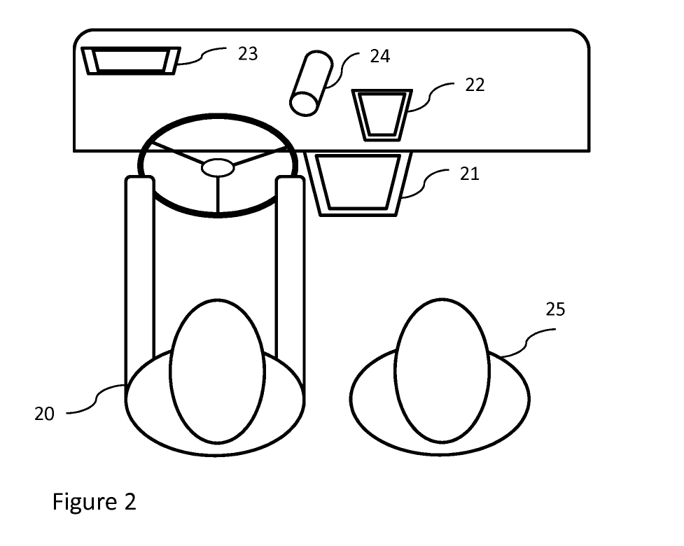

FIG. 1 is a simplified picture illustrating some examples of a person allocating visual attention. In situations B and E the person allocates the visual attention directly forward. In situation A the eyes are directed to the right and in situation C to the left. In situation D the head and eyes of the person are directed to the right and in situation F to the left. Several commercial applications and devices exist for eye tracking. Eye tracking is measuring either the point of gaze (direction of the eyes) or the motion of an eye relative to the head of a person. An eye tracker is a device that uses projection patterns and optical sensors to gather data about gaze direction or eye movements with very high accuracy. Eye tracker can be implemented in many ways. A non-exhaustive list of exemplary embodiments:
an attachment to the eye, such as a special contact lens with sensors,
an optical tracker, such as a video camera or other optical sensor,
electrodes placed around the eyes measuring eye motion.

Sometimes the direction of the gaze can also be indirectly inferred from mere face detection by analysing the angle of the face, for example facing to a mobile device or away from it. Many other means for monitoring the visual attention—direction of the gaze exist and they are applicable for this invention. Use of EEG (electroencephalograph) or magnetic resonance imaging (MRI) technologies may be applicable in some embodiments. Using these technologies it is possible to deduce from brain activity what the person is actually attending at or whether there is reduced processing on brain areas associated with driving-related activities.

The examples presented generally relate to situations when a driver is navigating a vehicle in various situations. Yet, the invention can be embodied in many other situations, too. For example the visual demands of any task interrupted by the use of any device requiring visual-manual interactions may be calculated, the allocation of visual attention between tasks monitored, and the person mentored if needed. Such situation can be for example a customer writing a text message with a mobile phone while at the cash register waiting his/her turn in line, or a pedestrian browsing music on a portable music player while walking or waiting the pedestrian lights to turn green.

As used herein, the term “driving” refers to navigating in movement controlled by a person, who can be called as a driver. Role of the driver when driving may differ from active—driving a traditional car—to more passive one—observing in an automatic train or such. It is to be noted that the role of the driver may differ and change with time for example when autonomous cars are considered. Yet the example embodiments of the current invention are relevant for the different roles. Furthermore it is to be noted that implementations of the example embodiments of the current invention for a person performing an act of moving like walking, running etc. does not fall out of the scopes of the claims. The example embodiments may be implemented also when the driver is moving in any way when he/she has any role or responsibility in navigating. For example when operating a fully or semi-automated train or flying an airplane even when auto-pilot is activated the driver/pilot/operator/navigator still has responsibility. One example of an embodiment without a vehicle involved is a method for managing visual attention, comprising the steps of:
storing user specific information in a user mentoring application;
receiving at the user mentoring application situation information about circumstances surrounding the user;
executing at the user mentoring application a visual demand algorithm using at least one of the situation information or user specific information;
executing an application for tracking direction of gaze of the user;
receiving at the user mentoring application information about the direction of the gaze of the user and measuring time when said direction of the gaze is allocated to something else than performing a task;
defining at the user mentoring application a threshold time for an intervention using the result received from the visual demand algorithm;
based on the determination that the measured time meets the intervention period the user is given mentoring by the user mentoring application to allocate more visual attention to performing said task.

FIG. 2 illustrates an exemplary embodiment where the driver 20 is seated inside a vehicle. The interior of the vehicle is shown in a simplified way depicting only necessary items. It is to be understood that the vehicle means any kind of mobile machine for transporting passengers or cargo (e.g. car, truck, motorcycle, train, bicycle, tractor, boat, aircraft, spacecraft). Yet the current invention is applicable also when a person is performing an act of moving like running, walking, riding on an animal like a horse or an elephant. In the depicted embodiment there are four potential sources of visual distractions shown: in-built multimedia system 21 which may also include vehicle related controls like climate adjustment, a driver mentoring device 22, a navigator device 23 and a passenger 25. Naturally there can be any number of other sources of visual distractions located anywhere inside the vehicle and the source can be something non-concrete, too. The driver may for example browse the interior of the car searching for something. The source of visual distraction may also be outside the vehicle; an advertising sign, a venue of commerce, attraction, special scenery etc. The eye tracking is used for monitoring if the driver is allocating the visual attention to navigating the vehicle or to something else considered as visual distraction. In FIG. 2 an eye tracker 24 is located on a dash of a vehicle. As described earlier the eye tracker 24 can also be located in an eye or surrounding an eye of the driver. A remote eye tracker 24 solution in a form of an optical sensor can be implemented anywhere where it can monitor the visual attention of the driver 20. In some embodiments the eye tracker can be implemented in or connected to the multimedia system 21, the driver mentoring device 22, the navigator device 23 or a mobile phone. There can also be more than one eye trackers, 24 in certain embodiments.

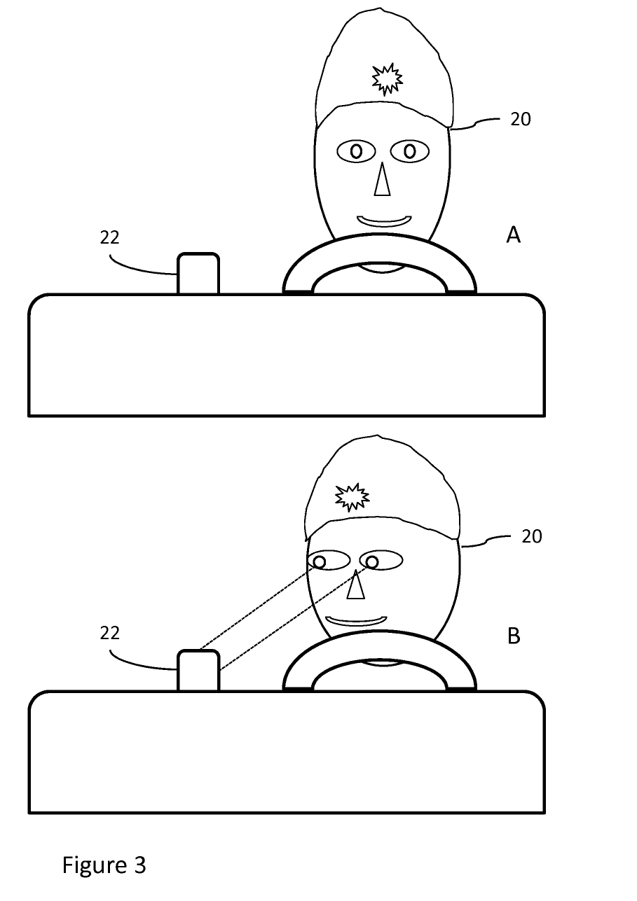

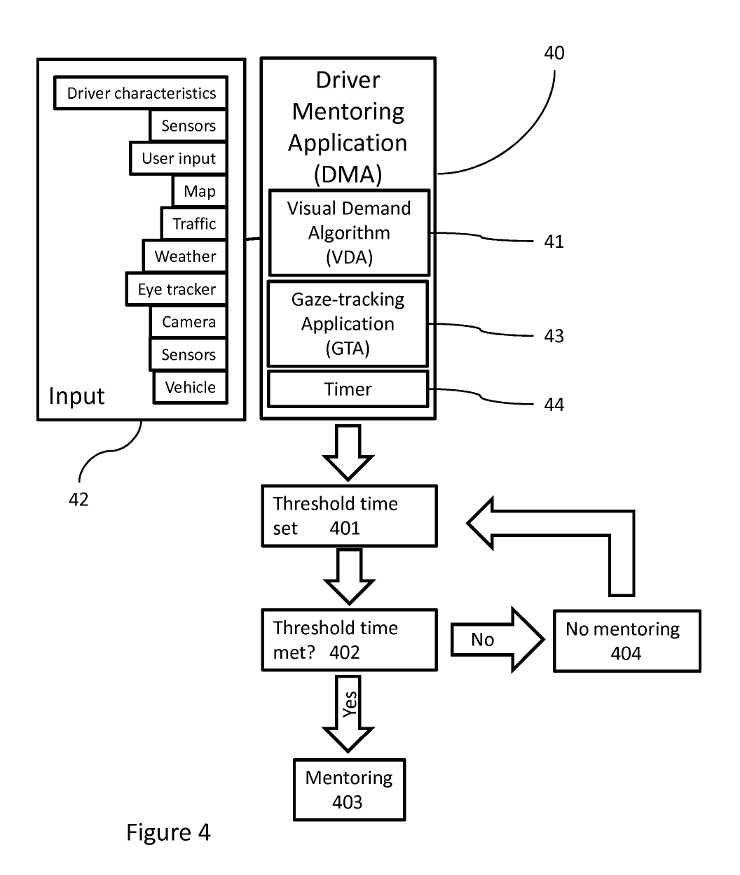

FIG. 3 illustrates two situations where the visual attention of the driver 20 is allocated to different objects. In situation A the visual attention is directed forward allocating it to navigating the vehicle and in the situation B the visual attention is directed to the driver mentoring device 22 which can be for example a mobile phone. Eye tracker is not depicted, but it could be for example implemented in the driver mentoring device 22. In the situation B the visual attention is clearly allocated to the driver mentoring device 22 but in the situation A it is not so clear—depending on the driving situation—the visual attention should perhaps be allocated to left or right e.g. while turning in a curve instead of staring forward looking at a advertising sign or some other source of visual distraction or other disturbance in front of the car. Also in the situation B—depending on the driving situation and driver characteristics—allocating visual attention to the mobile phone or driver mentoring device 22 might be a very low risk or no risk to driving safety.

FIG. 4 is a block diagram depicting a Driver Mentoring Application (DMA) 40 in accordance with certain exemplary embodiments. DMA 40 is an application for giving mentoring to a driver when needed. The DMA 40 application may be running e.g. in a mobile device like a mobile phone, personal digital assistant (PDA), tablet computer, portable media player, handheld game console, PC, navigator device, vehicle multimedia system, vehicle control system or any other suitable device. According to one embodiment Visual Demand

Algorithm (VDA) 41 is embedded to the DMA 40 but it can be also embodied in any other device connected to the DMA 40. DMA 40 utilizes information from many sources. The input 42 is a non-exhaustive list of information sources accessible by the DMA 40. In some embodiments at least one of the information sources for input 42 may be physically in the same device with the DMA 40 but according to some other embodiments the information sources for input 42 are physically remote from the DMA 40 running device but connected by any suitable communication path.

According to one embodiment of the invention a method for driver safety mentoring includes obtaining driver characteristics (input 42) in DMA 40. The DMA 40 also receives information about circumstances surrounding the vehicle (input 42). VDA 41 is executed and it calculates values describing level of visual demand using the input 42. A gaze tracking application (GTA) 43 is also executed which tracks the visual attention of the driver 20 and the information is provided to the DMA 40. When the information received from GTA 43 indicates that the driver 20 is allocating visual attention to something else (source of visual distraction) than navigating the vehicle a timer 44 is started to measure the glance time of distraction. The DMA 40 calculates and sets a situation specific threshold time 401 for possible intervention using the results from the VDA 41. The DMA 40 compares the measured glance time by the timer 44 and the set threshold time 401 and if the glance time measured is at least as long as the threshold time 401 the DMA 40 gives mentoring 403 to the driver 20. In other cases there is no need for mentoring.

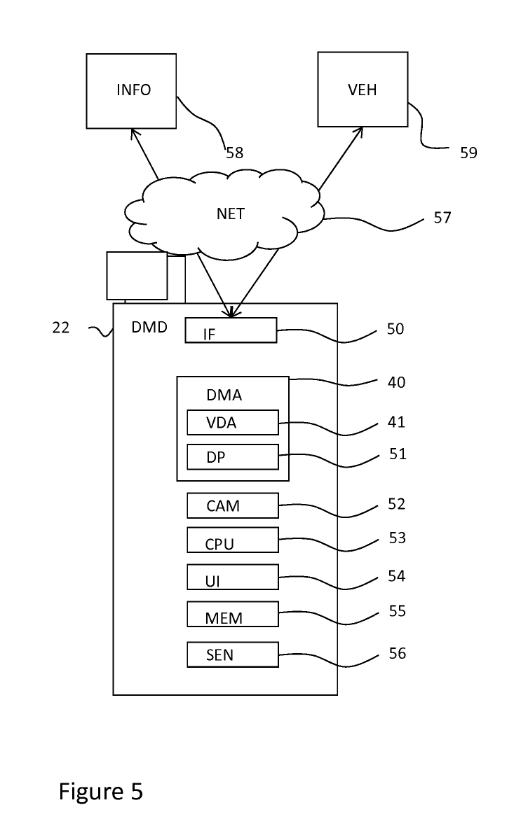

According to another embodiment driver characteristics can be obtained from input 42 and include similar information as Driver Profile (DP) 51 in FIG. 5. The information may include age, health, visual acuity, driving history of the driver and also tracked performance while driving like reaction time, stability of the driving, use of turn signals, obeying traffic regulations etc.

According to another embodiment the DMA 40 may detect that the driver 20 is using a mobile phone or other device while driving. Especially if the DMA 40 is installed and running on a mobile phone the DMA 40 receives user input (typing, browsing, gaming, calling . . . ) from input 42.

According to another embodiment the DMA 40 may detect issues related to the vehicle having an effect to visual demand level. In a case when input 42 includes a camera or other sensor device monitoring essentially in the direction of movement (windscreen) fog or ice may be detected on the windscreen as well as items attached to the windscreen or hanging e.g. from a rear view mirror.

According to another embodiment the DMA 40 receives map information from input 42 about the road, route or area the vehicle is on or facing. The map information may be real-time or statistical (historical) information about traffic, road conditions, altitude differences, curves, crossings, traffic lights, traffic signs, road construction works, accidents and so on.

According to another embodiment the DMA 40 receives traffic information from input 42 about the road, route or area the vehicle is on or facing. The weather information may be real-time or statistical (historical) information about temperature, rain, wind, visibility and so on.

According to another embodiment the mentoring 403 can be a visual, audible or tactile signal or based on sense of smell or taste or any combination of those. The signal can be given by the driver mentoring device 22, the multimedia system 21, the navigator 23, or any other in-vehicle information system or any combination of those. Means for the tactile signal can be implemented for example in driver's seat or steering wheel.

According to another embodiment the DMA 40 receives vehicle information from input 42 about status of the vehicle. The vehicle information may include vehicle trip starts and stops, engine operations, transmission operations, fuel efficiency, and the use of accelerators, brakes, and turn signals. Vehicle information may also include an on-board diagnostics “OBD” which can provide access to state of health information for various vehicle sub-systems based on vehicle's self-diagnostics. Modern OBD implementations use a standardized digital communications port to provide real-time data in addition to a standardized series of diagnostic trouble codes.

The threshold time can vary a lot. Drivers try to keep mean in-vehicle glance durations between 0.5-1.6 seconds in most traffic situations. However, for example when driving in a heavy traffic, bad weather with lots of sources of distraction around or merely in crossings with other traffic the threshold can be zero. On the other hand when driving a tractor on an empty field the threshold may be several seconds or in some other situations even longer without substantially increasing a risk of an accident.

For calculating the visual demand value of a specific driving situation, several factors should be taken into account. Environmental factors can include e.g. road type (crossing, intersection, roundabout, city, rural road, motorway, highway), road curvature, and lane width. Situational factors can include e.g. surrounding traffic, speed, and stability of the driving (lateral and longitudinal accelerations). Driver-related factors can include e.g._driving experience and age.

Environmental factors may further include plants, buildings, constructions, construction sites, pieces of art and other objects and structures near the road or route. For example houses, trees, fences etc. may block visibility in curves or crossings. The environmental factors may also change in time—plants grow, new buildings are built etc. The environmental factors may also change according to season—leafs may drop in the fall and new ones grow in spring, snow piles may form in winter and so on. The environmental factor may also be short-term, like a portable barrack at a constructions site, a broken vehicle etc.

In another example embodiment of the invention input 42 includes information received from a remote source. The information may include visual data like pictures or videos relating to a route or a route point. Sources of the visual data may include web services offering street-level views from various locations along the route. The driver mentoring device 22 may also gather visual data and store it locally or remotely for future use. Visual data may also be gathered from other sources, like separate car/dash cameras recording route when moving. Crowd sourcing or commercial services may also be used in gathering visual data.

The visual data may be used to calculate a value for at least one route point or a route using the Visual Demand Algorithm (VDA). The visual data may also be used to illustrate characteristics of the at least one route point or a route and such illustration may be used when planning a route or when driving or otherwise using the Driver Mentoring Application (DMA).

FIG. 5 illustrates an exemplary driver mentoring device (DMD) 22 in which an embodiment of the present invention may be implemented. The figure shows some relevant components of the device and external information sources where the driver mentoring device 22 can be connected to. The device may be a mobile phone, PDA, portable gaming device, tablet computer, pc, navigator, in-vehicle information system, driver safety device etc. It is also clear to a man skilled in the art that at least some of the components may be separate from the driver mentoring device 22 and connected with e.g. Bluetooth or a cable. For example a separate GPS-module or camera unit may be used.

In this embodiment DMA 40 is installed in the driver mentoring device 22. The DMA 40 is a user controllable application stored in a memory (MEM) 55 and provides instructions that, when executed by a processor unit (CPU) 53 of the driver mentoring device 22 performs the functions described herein. The expression “user-controllable” means that the driver mentoring device 22 in which the application is executed comprises a user interface (UI) 54 and the user may control execution of the application by means of the user interface, 54. The user may thus initiate and terminate running of the application, provide commands that control the order of instructions being processed in the driver mentoring device 22. Visual Demand Algorithm (VDA) 41 calculates a value describing how visually demanding a certain driving situation is for the driver using e.g. inputs 42 in FIG. 4. Driver profile (DP) 51 stores information about at least one driver. The information may include age, health, visual acuity, driving history of the driver and also tracked performance while driving like reaction time, stability of the driving, use of turn signals, obeying traffic regulations etc.

Information source (INFO) 58 may be a web server that has an IP address and a domain name. The information source may also be implemented as a cloud providing functions of the web server. The information source 58 can be a web site, a database, service etc.

Network (NET) 57 represents here any combination of hardware and software components that enables a process in one communication endpoint to send or receive information to or from another process in another, remote communication endpoint. NET, 57 may be, for example, a personal area network, a local area network, a home network, a storage area network, a campus network, a backbone network, a cellular network, a metropolitan area network, a wide area network, an enterprise private network, a virtual private network, a private or public cloud or an internetwork, a cable interface, vehicle BUS-system (CAN-Bus, J-Bus etc.) or a combination of any of these.

Information source (INFO) 58 may consist of one or many entities which may be for example a web server that has an IP address and a domain name. The information source may also be implemented as a cloud providing functions of the web server. The information source 58 entity can be a web site, a database, service etc. The information source 58 may provide to the DMA 40 information in practice any relevant information publicly available in the internet, information available via subscription, specific information available for DMA 40. The information may be real-time or statistical (historical) information about e.g. weather, traffic, road conditions, altitude differences, curves, crossings, traffic lights, traffic signs, road construction works, accidents and so on.

Vehicle's information system (VEH) 59 can include an audio system, a display, an engine control module, and third party safety devices. The DMA 40 can obtain data relating to vehicle trip starts and stops, engine operations, transmission operations, fuel efficiency, and the use of accelerators, brakes, and turn signals from the VEH 59. Vehicle's information system 59 may also include an on-board diagnostics “OBD” which can provide access to state of health information for various vehicle sub-systems based on vehicle's self-diagnostics. Modern OBD implementations use a standardized digital communications port to provide real-time data in addition to a standardized series of diagnostic trouble codes. Vehicle's self-diagnostics is also able to detect several safety related changes in a vehicle. For example it may detect a change in tire pressure or balancing of at least one wheel, any failure e.g. in steering or breaking system etc. can mean that more attention should be allocated to navigating the vehicle. Such changes or failures are sometimes very difficult to notice by the driver.

The driver mentoring device 22 further comprises an interface unit (IF) 50 providing means for connecting to INFO 58 and VEH 59 via NET 57. Interface unit 50 may include several means for connecting: wlan (Wi-Fi), cellular data, Bluetooth, RFID, USB, infrared, etc.

The driver mentoring device 22 further comprises at least one camera unit (CAM) 52. One camera unit 52 can be positioned in the front side of the driver mentoring device 22 and another on the rear side of the driver mentoring device 22. The camera unit 52 may provide DMA 50 information about the driver (where is the driver looking at, drowsiness . . . ), interior of the car (who is driving, other people or animals inside, driver smoking/eating/shaving . . . ), and surroundings (how the road looks through windscreen, other vehicles and obstacles . . . ). The camera unit 52 may be the gaze tracker 24 in FIG. 2. It is to be understood that the camera unit (CAM) 52 may be something else than a traditional camera device, too. It may utilize other areas of the light spectrum or use sound waves etc. Many other means for monitoring the visual attention—direction of the gaze exist and they are applicable for this invention. Use of EEG (electroencephalograph) or magnetic resonance imaging (MRI) technologies may be applicable in some embodiments. Using these technologies it is possible to deduce from brain activity what the person is actually attending at or whether there is reduced processing on brain areas associated with driving-related activities.

The driver mentoring device 22 further comprises sensors (SEN) 56 for sensing variable situations and conditions. The sensors 56 may provide DMA 40 information about driver, vehicle and surroundings. For example a GPS-module can give information about velocity, acceleration, g-forces, changes of direction etc. A microphone may provide DMA 40 information about a driver's activity (talking, singing, yawning . . . ), about the car (loud music, engine rpm, window open, convertible roof down . . . ) and surroundings (other traffic, wild life . . . ). Additional sensors 56 may include e.g. a heart rate sensors, brain wave sensors, gyroscope, acceleration sensor, thermometer etc.

Another embodiment of the invention is to define a visual demand value, VDV for each point of a road or route and store it in route information for example in map data of a navigator device or a route planning application. Using the VDV information for a route a driver is able to select a route from a number of routes in addition to existing distance and driving time. In some situations a driver might want to select a visually more demanding route in order to help to keep focused and in some other situation a less visually demanding road in order to be able to interact with a passenger while driving.

Usually in vehicles there is a power source available for the driver mentoring device 22. Yet in some cases, for example when the DMA 40 is running in a mobile phone and the device is being used while cycling or walking, a battery is needed. In situations where there is no fixed power available some power saving functions may be applicable. In the embodiments described above the DMA 40, VDA 41, timer 44 are always active when the application is launched monitoring the driver. Adequate polling times and other means clear for a man skilled in the art can be added to the method.

An example: Driver Mentoring Application implemented in a mobile phone

The term “mobile phone” means a cellular or mobile telephone having in addition to functionalities of standard, “traditional” mobile phones: voice and messaging functions and cellular data also advanced functionality. For example, mobile phones may have capabilities for installing 3^{rd} party software application in its memory. In addition to traditional cellular bearers they also provide Internet, WLAN (Wi-Fi), BLUETOOTH and RFID communication capabilities. Typically, modern mobile phones also have cameras for still images, full motion video, and media player applications for various media types. Many modern mobile phones have large displays and flexible data entry functionality on touch screens, keyboards etc. Often mobile phones also have more advanced internal circuitry and device functionality, such as GPS, accelerometers, gyroscopes, biometric sensors and other sensor functionality.

Driver 20 is seated on the driver's seat and navigating a car. The driver 20 has launched a DMA 40 in his mobile phone and placed the mobile phone on a rack on the dash of the vehicle as depicted in FIG. 2 (although the mobile phone could as well be located in the driver's hand). The mobile phone has camera unit 52—acting as an eye tracker 24—implemented on front side of the mobile phone facing to the driver 20. The mobile phone is connected to a network 57 using cellular data and obtains information from information source 58 and input 42. Using the obtained information VDA 41 calculates values for route points on the current road defining how visually demanding the points are for the driver 20. Together with the calculated value and other information a threshold time is set 401.

The camera unit 52 provides information to the DMA 40 and based on the information it determines whether the driver 20 is allocating his visual attention to navigating the vehicle or something else. When DMA 40 determines that the visual attention is allocated to something else than navigating a timer is started.

In situation A, FIG. 3 the driver 20 has allocated his visual attention to navigating the car and therefore there is no need to mentor him even if the traffic was heavy and the coming road points valued by the VDA 41 as visually highly demanding due many curves and crossings. As a matter of fact any intervention and mentoring by the DMA 40 might be distracting for the driver 20.

In situation B, FIG. 3 the driver has received a text message. Using the information received from the camera unit 52 the DMA 40 determines that the driver's 20 visual attention is allocated to the mobile phone instead of navigating the car. Based on the driver profile 51, current speed of the car, soon coming curve and a crossing the DMA 40 sets threshold time 401 as 0.8 seconds. The driver 20 does not allocate the visual attention back to navigating the car in 0.8 seconds and the threshold time is met 402, therefore mentoring 403 is given to the driver as an audible signal. Later on the crossing is passed and a less visually challenging road is ahead and the driver 20 starts to look at the mobile phone again. Together this and other information DMA sets a new threshold time 401 as 1.2 seconds and now the driver 20 is able to read the message and allocate his visual attention back to navigating the car before the threshold time is met 402. No mentoring needed.

According to one example embodiment in a situation where for any reason means for tracking the direction of the gaze is not available the intervention can be implemented using other means. An alternative signal responsive to senses may be for example a pulsing indicator, like an icon, a light, a sound, vibration or such to indicate passing of time. The alternative signal responsive to senses may also be arranged by visualization indicating progress like a progress bar, a pointer (pendulum or revolving), or other suitable means. Intervention period can be for example two pulses or two swings of a pointer or such, after which the gaze should be allocated to driving. Appropriate threshold for the intervention period can be calculated using the VDA for a current situation. The alternative signal responsive to senses may be continuous, where only the frequency, speed, tone etc. changes according to the situation. When the gaze has been focused on something else than driving it should be allocated back to driving when the driver notices the alternative signal responsive to senses indicating meeting the threshold—at the latest.

According to one example embodiment similar alternative signal responsive to sensesmethod can be implemented also when at least one of the situation information about the circumstances is not available for some reason. For example if the GPS-information is missing the VDA may define a threshold value for intervention period using the information available. If there is not enough situation information about the circumstances available a pre-set value for the intervention period can be used.

Improving the driver safety is an important task but the example embodiments of the current invention may also be used to make the driving more fluent and enjoyable in general. For example the driver can be informed about a closing ramp to take or to use a certain lane in rush time according to the information collected by the DMA or the driver can be informed about a high situational VDA value on a particular road and to take alternative route according to the information collected by the DMA.

It is apparent to a person skilled in the art that as technology advances, the basic idea of the invention can be implemented in various ways. The invention and its embodiments are therefore not restricted to the above examples, but they may vary within the scope of the claims.

We claim:

1. A method for managing driver safety, comprising the steps of:
receiving at the driver mentoring application situation information about circumstances surrounding a vehicle, wherein the situation information about circumstances surrounding the vehicle include map information;
executing at the driver mentoring application a visual demand algorithm for determining a visual demand value for at least one specific driving situation using the situation information;
executing an application for tracking visual attention of the driver;
receiving at the driver mentoring application information about the visual attention of the driver and measuring time when said visual attention is allocated to something else than navigating the vehicle;
defining at the driver mentoring application a threshold time for an intervention using the visual demand value for at least one specific driving situation from the visual demand algorithm; and
based on the determination that the measured time meets the threshold time for intervention, the driver is given mentoring by the driver mentoring application to allocate more visual attention to navigating the vehicle.

2. The method of claim 1, wherein situation information about the vehicle is received at the driver mentoring application and used in the visual demand algorithm.

3. The method of claim 1, wherein situation information about the circumstances inside the vehicle is received at the driver mentoring application and used in the visual demand algorithm.

4. The method of claim 1, wherein the situation information about circumstances surrounding the vehicle include weather information.

5. The method of claim 1, wherein the situation information about circumstances surrounding the vehicle include traffic information.

6. The method of claim 1, wherein the situation information about circumstances surrounding the vehicle include camera information.

7. The method of claim 1, wherein the situation information includes visual data received from a remote source.

8. The method of claim 1, wherein the mentoring is a signal to which senses are responsive.

9. The method of claim 8, wherein in case when the driver mentoring application does not receive enough situation information about circumstances surrounding the vehicle and/or information about the visual attention allocation of the driver an alternative signal to which senses are responsive is used to give mentoring to the driver.

10-15. (canceled)

16. A method of using a driver mentoring device, comprising:
receiving at the driver mentoring application situation information about circumstances surrounding a vehicle, wherein the situation information about circumstances surrounding the vehicle include map information;
executing at the driver mentoring application a visual demand algorithm for determining a visual demand value for at least one specific driving situation using the situation information;
executing an application for tracking visual attention of the driver;
receiving at the driver mentoring application information about the visual attention of the driver and measuring time when said visual attention is allocated to something else than navigating the vehicle;
defining at the driver mentoring application a threshold time for an intervention using the visual demand value for at least one specific driving situation from the visual demand algorithm; and
based on the determination that the measured time meets the intervention time giving the driver mentoring by the driver mentoring application to allocate more visual attention to navigating the vehicle.

17. The method of claim 1, further comprising steps of:
storing driver specific information in a driver mentoring application; and
executing at the driver mentoring application a visual demand algorithm for determining a visual demand value for at least one specific driving situation using the situation information.

18. The method of claim 16, wherein the method further comprises providing a mobile phone.

19. A method for a computer program product that is readable by a computer and encoding instructions for executing the method, the method comprising of:
receiving at the driver mentoring application situation information about circumstances surrounding a vehicle, wherein the situation information about circumstances surrounding the vehicle include map information;
executing at the driver mentoring application a visual demand algorithm for determining a visual demand value for at least one specific driving situation using the situation information;
executing an application for tracking visual attention of the driver;
receiving at the driver mentoring application information about the visual attention of the driver and measuring time when said visual attention is allocated to something else than navigating the vehicle;
defining at the driver mentoring application a threshold time for an intervention using the visual demand value for at least one specific driving situation from the visual demand algorithm; and
based on the determination that the measured time meets the threshold time for intervention, the driver is given mentoring by the driver mentoring application to allocate more visual attention to navigating the vehicle.

20. The method of claim 19 further comprising steps of:
storing driver specific information in a driver mentoring application;
executing at the driver mentoring application the visual demand algorithm for determining the visual demand value for at least one specific driving situation using the driver specific information.

21. The method of claim 19, wherein situation information about the vehicle is received at the driver mentoring application and used in the visual demand algorithm.

22. The method of claim 19, wherein situation information about the circumstances inside the vehicle is received at the driver mentoring application and used in the visual demand algorithm.

23. The method of claim 19, wherein the situation information about circumstances surrounding the vehicle includes weather information.

24. The method of claim 19, wherein the situation information about circumstances surrounding the vehicle includes traffic information.

25. The method of claim 19, wherein the situation information about circumstances surrounding the vehicle includes camera information.

26. The method of claim 19, wherein the mentoring is a signal to which senses are responsive.
